(19) United States
(12) Patent Application Publication
(10) Pub. No.: US 2013/0206449 A1
(43) Pub. Date: Aug. 15, 2013

(54) Method and apparatus for reduction of skin effect losses in electrical conductors

(71) Applicant: Timothy Raymond Pearson, Belvidere, IL (US)

(72) Inventor: Timothy Raymond Pearson, Belvidere, IL (US)

(21) Appl. No.: 13/385,244

(22) Filed: Feb. 9, 2012

(51) Int. Cl. H01B 7/00; H01B 5/00

(52) U.S. Cl. 174/110 R; 174/126.1

(57) ABSTRACT

A novel method of reducing the undesired skin effect in electrical conductors is presented. Specific applications including efficient power transmission and high frequency magnetic field generation are discussed, and the advantages over prior art are mentioned. The present invention modifies the inductance of a given conductor, allowing the current flowing in the surface of the conductor due to skin effect to diffuse through the remaining conductor area. Inductance is modified in a distributed, continuous fashion via external magnetic structures, ensuring both manufacturability and usability of the resultant conductor. When skin effect inside a conductor is reduced, power loss of transmitted electrical signals is reduced accordingly. Therefore, the present invention represents a significant improvement over prior art.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Without limiting the scope of the invention, its background will be discussed within the framework of general electromagnetics. A significant and persistent problem in high frequency electrical circuits is high loss caused by the skin effect. The skin effect is caused by current crowding near the surface of a conductor, and reduces the effective cross sectional area available for conduction in proportion to the square root of applied signal frequency. At relatively high frequencies, for example those above 1 MHz, the skin depth is less than 0.1 mm. This causes a highly undesirable reduction in effective conductor area, and a corresponding increase in conductor resistive loss. Furthermore, as resistive loss increases with the square of current density, and skin effect increases current density proportionally to the square root of frequency, the net result is that the skin-effect resistive power losses increase linearly with increasing frequency. This situation is highly undesirable, as it prevents the efficient transmission of large amounts of high frequency electrical energy through reasonably sized conductors. Additionally, the skin effect can introduce distortion into the applied electrical signal via nonlinear delay in the inner portions of the wire. Finally, high frequency, high magnetic field generation has been historically limited by the skin effect, due to the fact that overcoming the resultant high losses requires both additional high frequency electrical power and extensive cooling of the entire generation apparatus to remove the wasted energy.

Many attempts have been made over time to solve this problem. One of the earliest known effective systems to achieve this goal is Litzendraht (“Litz wire”), which still is in use today. Unfortunately, it suffers from a number of limitations, including high DC resistance and reduced function above 2 MHz. Other systems have been described over time, but were not successfully commercialized. Examples of such work with laminated conductors are given in “Reduction of Skin-Effect Losses by the Use of Laminated Conductors” by A. M. Clogston (1951), and “Implementation of Multilayered Conductor Structures on RF Cavity Surfaces” by Y. Iwashita (2010). While these existing systems are a significant step forward from Litz wire, their complex structures and limited usefulness have severely inhibited commercialization.

Other prior art, which does not aim to reduce skin-effect losses but bears a resemblance to certain embodiments of the present invention, includes U.S. Pat. No. 4,843,356 and U.S. Patent Application 2006/0267705. The former presents a method for including a distributed shunt inductance in the insulation of an electrical cable in order to compensate for undesired shunt capacitance therein. The method and structures described do not permit the usage of inexpensive and readily available high-permeability materials, despite superficial similarities to the structure of the present invention. Specifically, it should be noted that in the prior art the magnetic structures completely enclose the conductive elements, and that the magnetic materials described exhibit a characteristic low permeability and high electrical resistance, limiting their usefulness in mitigating skin effect losses. In another prior embodiment, a segmented cable is presented; however, the conductor gaps in that cable are not required in the present invention. Finally, no attempt to utilize high-permeability materials to reduce skin effect losses at high frequencies has been shown in the prior art.

The latter U.S. patent application describes a method of equalizing skin-effect losses across frequency. This differs from the present invention in that the prior art increases resistance at DC and low frequencies instead of lowering high frequency resistance. The difference in structure and function is substantial, with the prior art being wholly unsuited for high power, high frequency signal transmission due to its large resistance and subsequent power loss.

A final class of prior art has recently emerged in “Magnetic-Multilayered Interconnects Featuring Skin Effect Suppression” by Y. Zhuang et. al. (2008). This prior art uses a multilayered structure to generate an effective negative permeability above a critical frequency. The present invention does not use interleaved conductors and magnetic materials to achieve reduction in skin effect as shown in the prior art. Additionally, it does not suffer from the effective frequency limitation of the prior art, or the manufacturing difficulties associated with such a structure.

### BRIEF SUMMARY OF THE INVENTION

This invention provides a new method and apparatus for the reduction of skin-effect losses in an electrical conductor of arbitrary shape. The invention consists of a central conductor or laminated conductor stack, near which are placed one or more low-loss magnetic materials. These magnetic materials can be offset from the conductor surface and/or each other via a low-loss dielectric such as PTFE where advantageous, but this is not required. Additionally, these magnetic materials either may be continuous or broken into discrete segments depending on the material utilized. Precise control of magnetic material thickness, insulator thickness if present, and total conductor thickness is mandatory to achieve the largest reduction in skin-effect losses.

Without limiting the scope of the invention, a specific conductor type and shape will be discussed below so as to provide an example of the functional principles disclosed in the present invention. Starting with a laminated stack of identical copper films, where each film has a thickness much less than its width or length, and such films are interleaved vertically with thin insulating films of similar aspect ratio, it can be shown that the mutual inductance of the outer conductors is much less than that of the inner conductors. This is the essence of the skin effect from an electrical perspective: specifically, that the inner conductor impedance is significantly higher than the outer conductor impedance. Under such conditions, standard circuit theory predicts that the majority of the current will flow in the outer conductors, and, in fact, such predictions exactly match the known characteristics of the skin effect. At DC and low frequency, resistive losses in the wire dominate over any impedance caused by the mutual inductance, whereas at high frequency this mutual impedance dominates, giving rise to imbalanced current flow.

Using this electrical model as a guide, it would be logical to increase the impedance of all conductors so as to reduce the current preferentially flowing in the outer conductors. Increasing the resistance of any of the conductors would be counterproductive, as the energy flowing therein would be wasted as heat. Therefore, a low-loss inductive impedance should be introduced into each branch of the system. This additional impedance will act to equalize the currents flowing in each branch, diluting the mutual inductance differences between the layers and thereby countering the skin effect itself. Even a relatively small or incomplete equalization of the branch impedances will have a profound effect on total system loss; this is due to the large variation of effective conductor area with respect to branch current imbalance.

While it may be obvious to install discrete inductors in each branch to accomplish the desired equalization, this approach fails for several reasons. The inductors will, by necessity, contain a relatively small conductor cross-sectional area compared to the main laminated conductor stack, as well as possess considerable internal wire length, thereby causing unacceptable loss. Other reasons include difficulty of manufacturing, and the conversion of the resultant system from a true distributed impedance to a partially lumped impedance; the latter problem, especially, would severely limit usefulness of the system at high frequencies.

Therefore, it is advantageous to utilize distributed impedance modification of the conductive layers. This can be achieved through the use of the aforementioned magnetic material; such a material can be effectively continuous and constant along the length of the system, preserving the desirable distributed properties of the system. The magnetic material, when applied to the outside of the conductor stack, acts to significantly increase the inductance of all conductors within the stack, thus achieving the desired equalization of branch impedances.

Given the high level of impedance equalization possible with this method, and the fact that the lumped circuit properties of the conductor stack are purposefully left unused, the use of laminated conductors is not required. The present invention will reduce the skin-effect losses even if a solid rectangular conductor is utilized, provided that the magnetic material structure and dimensions are properly matched to the physical structure and dimensions of that specific conductor.

Without limiting the scope of the invention, several problems in the prior art and their solution in this invention are discussed herein. With respect to the problem of severe power loss of high frequency signals due to skin effect, a new method has been described to reduce and/or eliminate the skin effect and, thereby, the loss associated with it. With respect to the problem of distortion caused by skin-effect related delay in the inner portions of the conductor, a new method has been described to reduce and/or eliminate the skin effect and, thereby, the distortion associated with it. The present invention also enables high frequency, high magnetic field generation, as it reduces the undesired skin-effect losses without significantly affecting the intensity or distribution of the magnetic field produced outside the wire when high frequency electrical current is applied.

### BRIEF DESCRIPTION OF THE SEVERAL VIEWS OF THE DRAWING

FIG. 1 is a perspective view of the preferred embodiment of the present invention.

FIG. 2 is a sectional view of the embodiment of the present invention illustrated in FIG. 1.

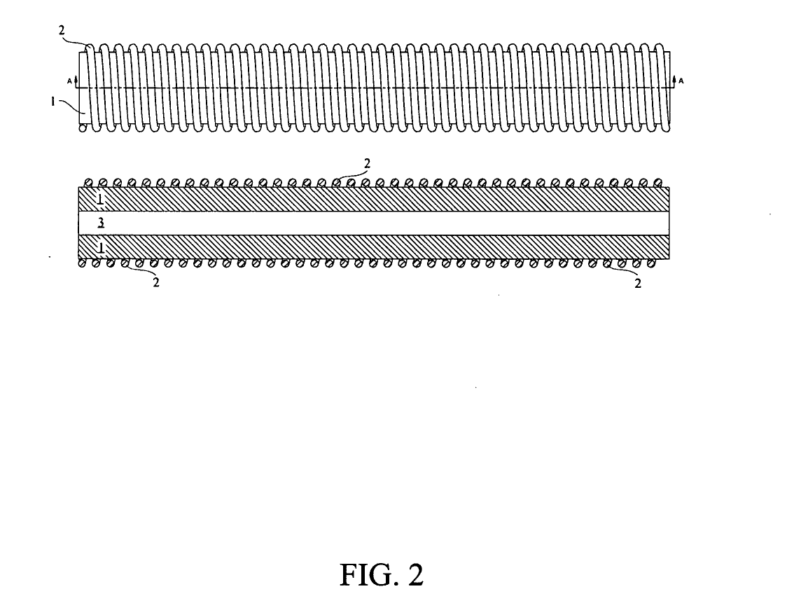

FIG. 3 is a perspective view of another embodiment of the present invention.

FIG. 4 is a sectional view of the embodiment of the present invention illustrated in FIG. 3.

FIG. 5 is a perspective view of another embodiment of the present invention.

FIG. 6 is a sectional view of another embodiment of the present invention.

### DETAILED DESCRIPTION OF THE INVENTION

While the design and usage of specific embodiments are discussed below, it should be understood that these discussions do not limit the scope of this invention, and that the broad concepts which are part of this invention may be usable in other specific embodiments which are not discussed below.

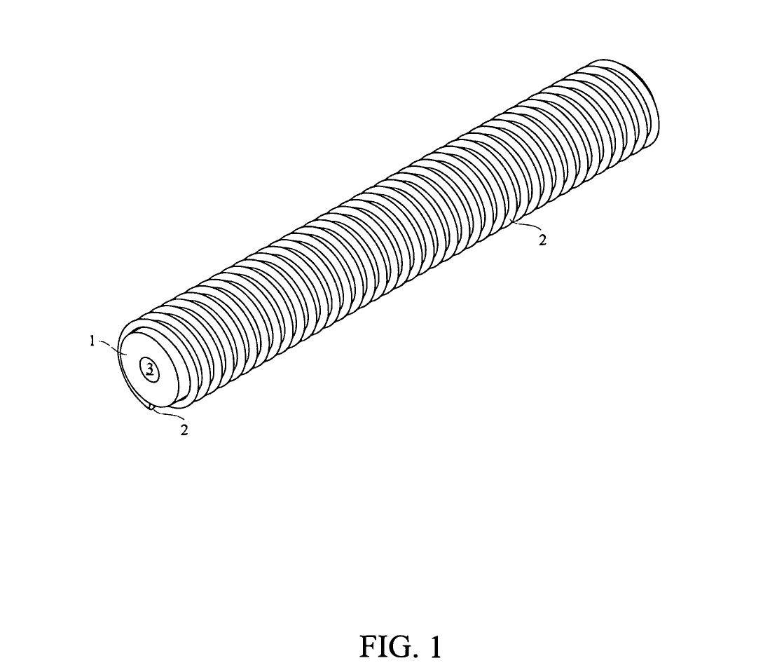

The skin-effect compensator of the present invention includes a conductor or conductors 1 through which electrical signals are transmitted. Also provided are a material or materials with a relative permeability greater than one 2, hereinafter referred to as compensators, and an optional cavity 3. In the preferred embodiment of the present invention, shown in FIG. 1, the compensator is fashioned into a helical structure and placed around conductor 1, with an insulator optionally provided between the compensator 2 and conductor 1. Spacing provided between turns within the compensator 2 acts to reduce or eliminate eddy current losses within the compensator material, allowing the use of electrically conductive, high permeability materials within the present invention. In one embodiment of the invention, a portion of the conductor 1 may be removed, forming cavity 3, inside which cooling fluid or gas may be present. While the use of a helical compensator 2 is illustrated in FIG. 1, it should be understood that isolated rings, high resistance ferrites, or any other means of substantially inhibiting current flow parallel to the conductor 1 within the compensator 2 may be utilized without deviation from the scope of this invention.

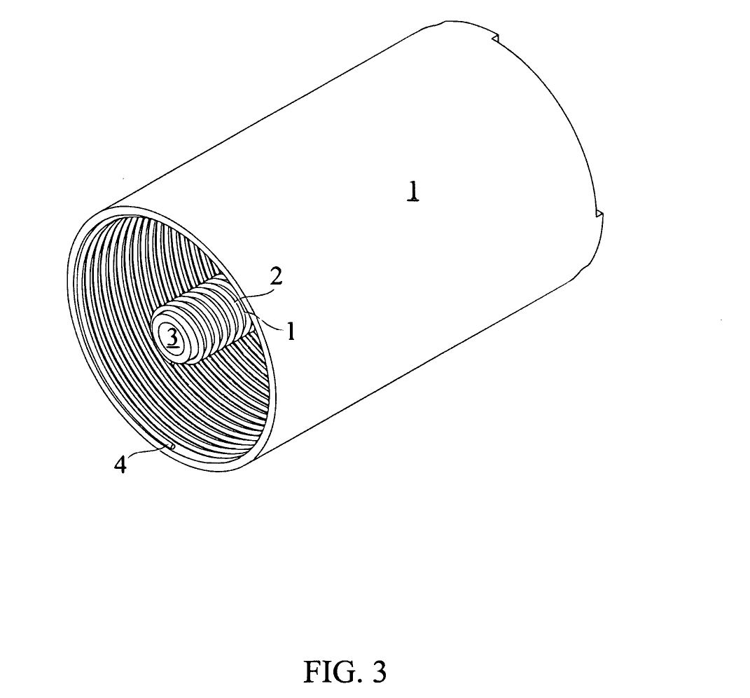

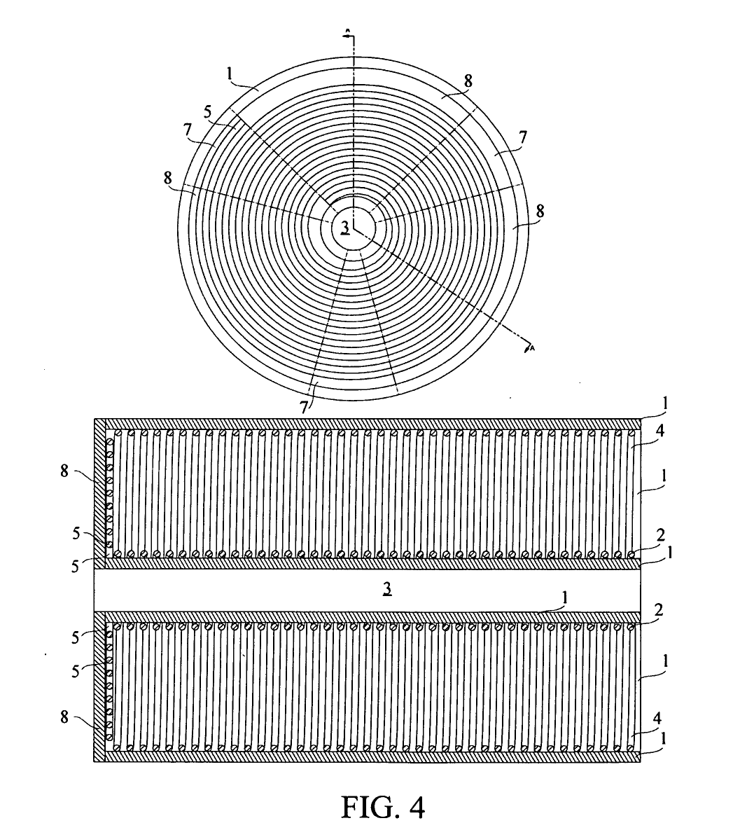

In another embodiment of the invention, multiple compensated conductors are arranged to form an electrical resonator as is well known in the art. Referring to the drawings, FIG. 3 is a perspective view of this embodiment, illustrating the use of separate compensators 2 and 4, each acting to reduce the skin effect flowing on the electrically active surfaces of conductive resonator walls 1. The inner resonator may optionally contain a cavity 3, inside which cooling fluid or gas may be present. Additionally, this embodiment of the invention illustrates the usage of a compensator formed into a flat helix 5, as shown in FIG. 4, in order to reduce the skin effect present within planar conductors 8. Optional gaps 7 in the end plate may be provided to allow flow through the resonator. If gaps 7 are utilized, the adjacent sections of compensator 5 may also be removed. While the use of a helical compensator 5 is illustrated in FIG. 4, it should be understood that isolated rings, high resistance ferrites, or any other means of substantially inhibiting current flow within the compensator 5 parallel to the current flow within conductor 8 may be utilized without deviation from the scope of this invention.

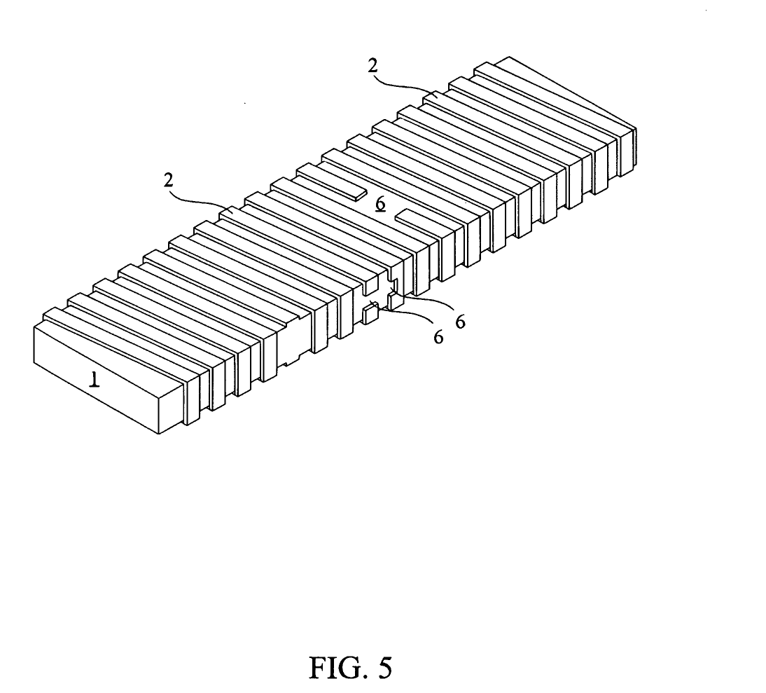

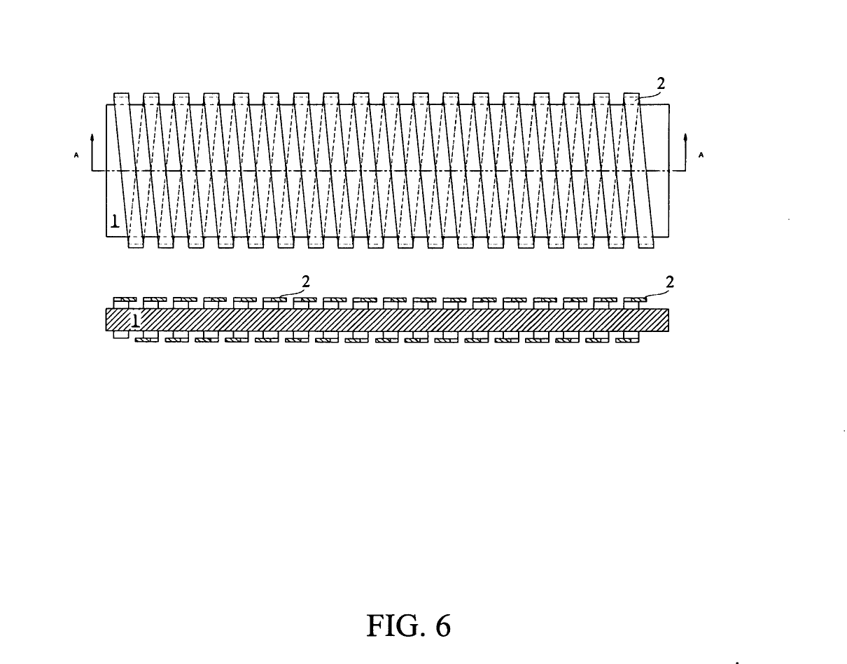

In another embodiment of the invention, a compensated conductor is formed on a planar surface via deposition of a pattern of magnetic material 2 above and below a pattern of conductive material 1 and magnetic material 2, the result of which is depicted in FIG. 5. In another embodiment of the invention, depicted in FIG. 6, the compensators 2 may be held at a distance from conductors 1, for example to aid in manufacturing or to alter the performance of the present invention.

All embodiments of the present invention may contain defects 6 within the compensator 2 and/or conductor 1, as shown in FIG. 5, without deviating from the scope of this invention. It should be understood that trivial variations, such as altering the cross sections of the electrical conductors and associated compensators from circular to elliptical or rectangular, fall within the scope of the present invention.

It should be apparent that an improved electrical conductor may be utilized for many different applications as well known in the art, and that these applications are too numerous to fully list here. Without limiting the scope of the invention, several potential applications will be mentioned below. The structure shown in FIG. 1 is readily used as a conductor for a radio frequency coaxial or triaxial cable, as is well known in the art. In addition to being used as a center conductor, a larger variant of the same structure may be utilized for the various shielding layers of said cable. The structures shown in FIG. 1, FIG. 5, and FIG. 6 may have applications in microelectronics, to reduce the loss of high frequency interconnects. The embodiment shown in FIG. 1 is readily used for low-loss electrical power transmission, for example, at high electrical and mechanical tension and at low frequencies, such as 50 or 60 Hz. The performance of all embodiments will be enhanced by the use of low-resistance conductive materials, such as superconductors, although they also will function with the use of readily available conductive materials such as copper or silver. All embodiments may be insulated with an external, conformal insulation material for electrical isolation and mechanical durability, as is well known in the art.

What I claim:

1. A device for reducing the skin-effect losses of an electrical conductor, consisting of:
an electrical conductor of arbitrary cross section and structure; and
one or more compensators, consisting of a material with relative magnetic permeability greater than one and substantially taking the form of a helix, where the the electrical conductor is located inside said compensator or compensators.

2. A device for reducing the skin-effect losses of an electrical conductor, consisting of:
an electrical conductor of arbitrary cross section and structure; and
one or more compensators, consisting of a material with relative magnetic permeability greater than one and acting to increase the inductance throughout the cross section of said conductor, where each compensator is fashioned to reduce internal current flow in a direction substantially parallel to the typical current flow within any adjacent electrical conductor or conductors.

3. The device of claim 2, where electrical insulators are provided between compensators and conductors.

4. The device of claim 2, where a structural material is provided within the electrical conductor to increase mechanical strength of the resultant device.

5. The device of claim 2, where a hollow cavity is provided within the electrical conductor.

6. The device of claim 3, where a structural material is provided within the electrical conductor to increase mechanical strength of the resultant device.

7. The device of claim 3, where a hollow cavity is provided within the electrical conductor.

8. The device of claim 5, where a gas or fluid is used to fill the cavity and said fill material may be circulated through the device via an external pump.

9. The device of claim 7, where a gas or fluid is used to fill the cavity and said fill material may be circulated through the device via an external pump.

10. A device for reducing the skin-effect losses of an electrical resonator, consisting of a plurality of concentric, isolated electrical conductors of arbitrary cross section and structure;
one or more electrical conductors, hereinafter referred to as interconnect conductors, placed substantially perpendicular to and electrically connecting any combination of said concentric electrical conductors; and
one or more compensators, consisting of a material with relative magnetic permeability greater than one and acting to increase inductance throughout the cross section of said conductors, where each compensator is fashioned to reduce internal current flow in a direction substantially parallel to the typical current flow within any adjacent electrical conductor or conductors.

11. The device of claim 10, where a flat helical compensator is provided adjacent to any interconnect conductor.

12. The device of claim 10, where electrical insulators are provided between compensators and conductors.

13. The device of claim 10, where a structural material is provided within any of the electrical conductors to increase mechanical strength of the resultant device.

14. The device of claim 10, where a hollow cavity is provided within any of the electrical conductors.

15. The device of claim 14, where a gas or fluid is used to fill any cavity or cavities, and said fill material may be circulated through the device via an external pump.
